(19) United States
(12) Patent Application Publication
(10) Pub. No.: US 2026/0301137 A1
(43) Pub. Date: Oct. 1, 2026

(54) RECONSTRUCTING OBSTRUCTED REQUIRED VISUAL INFORMATION IN AN OBSTRUCTED/OBSCURED IMAGE

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/094,955

(22) Filed: Mar. 30, 2025

(51) Int. Cl. G06T 5/77; G06V 10/74

(52) U.S. Cl. CPC G06T 5/77; G06V 10/761

(57) ABSTRACT

An electronic device provides various techniques for reconstructing required visual information that is at least partially omitted from or partially obstructed in a visual media file. In response to a trigger to provide a visual media file to a receiving application that retrieves content from the visual media file, the processor is configured to cause the electronic device to identify visual information that is prescribed visual information required by the receiving application from the visual media file. The processor identifies unobstructed visual information in the first visual media. Based on the unobstructed visual information and the prescribed visual information, the processor identifies required visual information that is at least partially omitted from or partially obstructed within the visual media file. The processor reconstructs a second visual media file by inpainting, into the visual media file, the required visual information retrieved from a source external to the visual media file.

### BACKGROUND

### 1. Technical Field

The present disclosure relates generally to user electronic, and more particularly, to user electronic devices having a graphical user interface.

### 2. Description of the Related Art

Portable electronic communication devices, particularly smartphones, have become ubiquitous. People all over the world use such devices to stay connected. With incorporation of front and back cameras and graphical displays, these devices are used frequently for capturing and replaying or sharing visual content such as photographic images and video recordings. The convenience and functionality of portable electronic communication devices enable the devices to be used to support personal and business productivity tasks such as completing electronic transactions, generating and submitting transaction/expense reports, completed questionnaires, filled-out forms, etc., and sharing and/or uploading content.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is a simplified block diagram of operative components and example implementation of the electronic device with a visual media selective reconstruction (VMSR) module for reconstructing required visual information that is at least partially omitted from or partially obstructed within a visual media file, according to one or more embodiments;

FIG. 3 is an example visual information template containing examples of required visual information, according to one or more embodiments;

FIG. 4 is an obstructed image of a physical transaction record being held at one corner by a hand that obstructs a portion of descriptive visual information, according to one or more embodiments;

FIG. 5 is a format template associated with the physical transaction record of FIG. 4, according to one or more embodiments;

FIG. 6 is a transaction record associated with the transaction, containing at least some of the required visual information that was at least partially omitted from or partially obstructed within the obstructed image of FIG. 4, according to one or more embodiments;

FIG. 7 is an example reconstructed image with descriptive information to realistically and accurately portray the physical transaction record without omission or obstruction of required visual information, according to one or more embodiments;

FIG. 8 illustrates a touch display of the electronic device presenting camera control affordances and notifications regarding visual media selective reconstruction features, according to one or more embodiments;

FIG. 9A-9B (collectively “FIG. 9”) is a flow diagram presenting a computer-implemented method for reconstructing required visual information that is at least partially omitted from or partially obstructed within a visual media file, according to one or more embodiments; and

FIG. 10 is a flow diagram presenting a second computer-implemented method augmenting the method of FIG. 9 with various techniques for capturing the visual media file and for determining what visual information is required or not required, according to one or more embodiments.

### DETAILED DESCRIPTION

According to aspects of the present disclosure, an electronic device, a method, and a computer program product provide various techniques for reconstructing required visual information that is at least partially omitted from or partially obstructed within a visual media file. In an example, the visual media file is a financial transaction record such as a receipt that needs to be provided with an expense report. In another example, the visual media file includes specific factual information such as a date or location of a transaction that is needed by a recipient. A user can share the visual media file rather than having to find and enter the specific factual information. By including the visual context of the specific factual information, the recipient may understand the source and authoritative nature of the specific information without the inconvenience of elaboration by the user. In today's digital age, images with obstructed or missing information are common, whether due to physical obstructions or digital artifacts. Filling in these gaps is a valuable tool for improving visual completeness and usability, particularly in areas such as photo editing, historical photo restoration, and document management. However, the challenge becomes more complex when the context of consumption dictates the need for specific, fact-based information requiring reconstruction while, for processing efficiency, not reconstructing other portions of the information that are not required.

The present disclosure provides a solution that not only repairs obstructed images but also does so in a contextually relevant manner, ensuring only the necessary required information is reconstructed based on the specific purpose of the image. Accordingly, processing resources are conserved, i.e., not utilized to reconstruct information that is not specifically required. In an example, the present disclosure addresses document sharing scenarios where a partially obstructed receipt for an expense reimbursement should only reconstruct portions related to the reimbursement process (e.g., price, date). In another example, the present disclosure addresses a personal use scenario where a user requests a specific fact, such as an address. A reconstructed image such as an obstructed receipt has the requested specific fact reconstructed, while other non-relevant (i.e., not required) details remain unchanged even if omitted from or obstructed within the partially reconstructed receipt. Traditional image reconstruction techniques, which fill in obstructed areas without considering the user's intent or consumption context, are often inefficient, wasting processing power by reconstructing irrelevant sections, and risking privacy breaches by revealing unnecessary information. These challenges highlight the need for a context-aware reconstruction process that adapts based on user-specific requirements.

According to one or more embodiments, an electronic device includes memory that stores a visual media selective reconstruction (VMSR) module. A processor of the electronic device is communicatively coupled to the memory. In response to a trigger to provide a first visual media file to a receiving application that retrieves content from the first visual media file, the processor is configured to cause the electronic device to identify visual information that is prescribed visual information required by the receiving application from the first visual media file. The processor is configured to cause the electronic device to identify unobstructed visual information in the first visual media. Based on the unobstructed visual information and the prescribed visual information, the processor is configured to cause the electronic device to identify required visual information that is at least partially omitted from or partially obstructed within the first visual media file. The processor is configured to reconstruct a second visual media file by inpainting, into the first visual media file, the required visual information retrieved from a source that is external to the first visual media file.

According to one or more embodiments, a computer-implemented method is provided for reconstructing required visual information that is at least partially omitted from or partially obstructed within the visual media file. In response to a trigger to provide a first visual media file to a receiving application that retrieves content from the first visual media file, the method includes identifying visual information that is prescribed visual information required by the receiving application from the first visual media file. The method may include identifying unobstructed visual information in the first visual media file. Based on the unobstructed visual information and the prescribed visual information, the method includes identifying required visual information that is at least partially omitted from or partially obstructed within the first visual media file. The method includes reconstructing a second visual media file by inpainting, into the first visual media file, the required visual information retrieved from a source that is external to the first visual media file.

Further embodiments provide a computer program product that includes: a non-transitory computer readable medium; and program code on the computer readable medium that, when processed by a processor of an electronic system, configures the processor and/or the electronic system to perform functions of the above-described method.

The present disclosure supports increasingly smart connection between user electronic devices, such as a smartphone and a personal computer (PC). In response to prompt to submit an expense report for the latest trip, the user may select a function or input a command to: “Submit/upload expense report with receipts from the Chicago trip”. According to aspects of the present disclosure, an artificial intelligence (AI) engine of the electronic device locates the relevant receipts based on location, time and type of transaction. According to aspects of the present disclosure, the AI engine identifies particular visual media images (e.g., pictures of the receipts) that are required to contain relevant information to support particular information required for the expense report. In particular, the present disclosure provides for selective reconstruction of a visual media file that has required information that is at least partially omitted from or obscured within the visual media file.

Tools exist to remove an image of a person or other object from a digital photographic image. Improvements of the technology have included inpainting background imagery that realistically erases the person or the other object. The present disclosure does not merely attempt to extend a background across an omitted or obscured object but rather leverages technology such as generative artificial intelligence (AI) to replace the information that is at least partially omitted from or is obscured within required visual media with intelligible visual information content that is extracted from another source. In one or more embodiments, non-required visual information that is proscribed from inclusion (e.g., confidential or private information) may be retracted, obscured, omitted or replaced with generic replacement information in a reconstructed visual media file. According to aspects of the present disclosure, degradations to the image (e.g., obscuring object or damage to a surface containing the required visual information) is removed and the required visual information is reconstructed to appear as what would be expected without the degradation. According to additional aspects of the present disclosure, generative AI is used to remove smaller portions of a visual image file to remove personal identifiable information (PII) such as vehicle registration numbers, personal identification numbers, etc., that are replaced with similar intelligible small images, retaining the general adornments of objects in the photographic image. Unlike traditional AI systems that rely on explicit programming and rules, generative AI has the ability to generate content, such as text, images, or even music, autonomously. At its core, generative AI utilizes deep learning models, often built upon architectures, such as Generative Pre-trained Transformer (GPT), to understand patterns, relationships, and features within vast datasets. These models, trained on diverse and extensive data, gain the capability to generate new, coherent content that often mimics human-like creativity. One aspect of generative AI is its versatility, being applicable across various domains from natural language processing to image synthesis and beyond. In the realm of natural language, for instance, generative AI can compose text, answer questions, and even engage in coherent conversations, showcasing its potential in human-like language generation.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., does not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

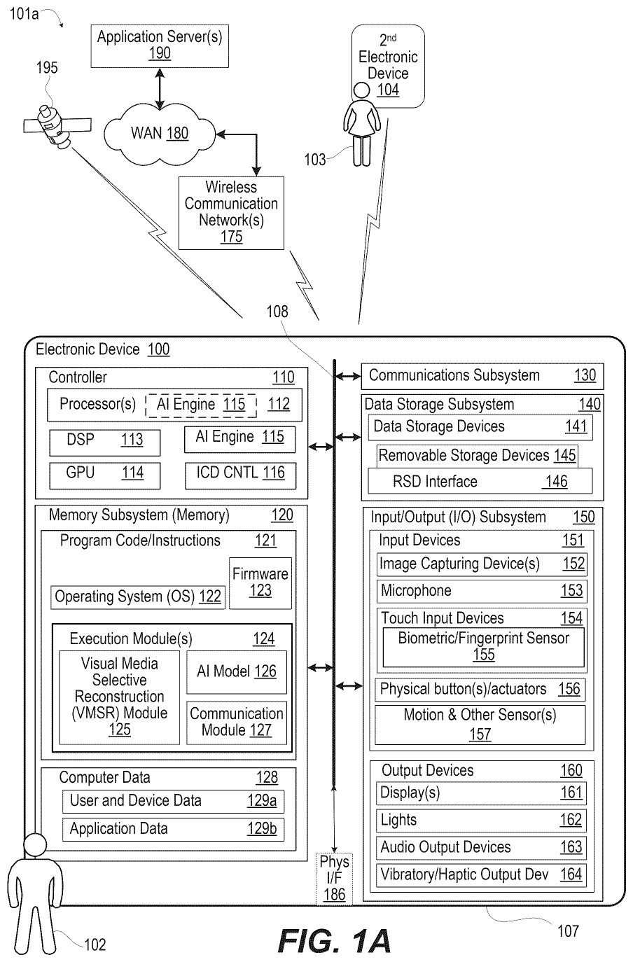

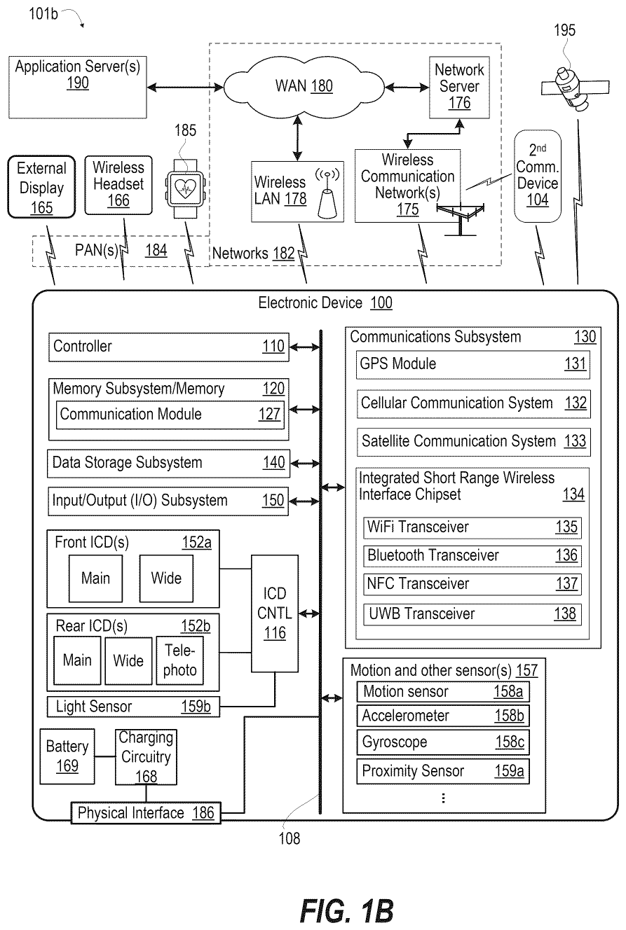

Those of ordinary skill in the art will appreciate that the hardware components and basic configuration depicted in the following figures may vary. For example, the illustrative components within electronic device 100 (FIG. 1A-1B) are not intended to be exhaustive but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Examples of electronic device 100 can include, but are not limited to, mobile devices, a notebook computer, vehicle-integrated communication system, a mobile phone, a smart phone, a digital camera with enhanced processing capabilities, a smart watch, a tablet computer, a heads up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as a communication device. In one or more embodiments, electronic device 100 does not include communication functions.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 includes, without limitation, visual media selective reconstruction (VMSR) module 125, which provides the features and operating functionality of the disclosed embodiments when the corresponding program instructions of VMSR module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within VMSR module 125 and is trained to support the AI features of VMSR module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

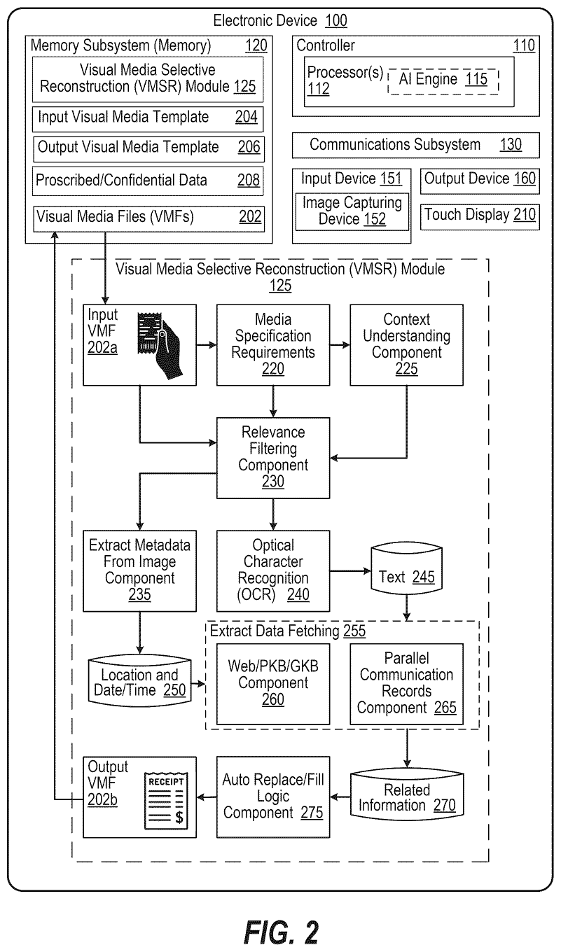

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, VMSR module 125 can include program instructions for reconstructing required visual information that is at least partially omitted from or partially obstructed within a visual media file, for triggering the reconstruction based on capturing an image, and for determining required visual information. An example implementation of VMSR module 125 is described below with regard to FIG. 2.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of VMSR module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152 microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (e.g., touch input device 154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of VMSR module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

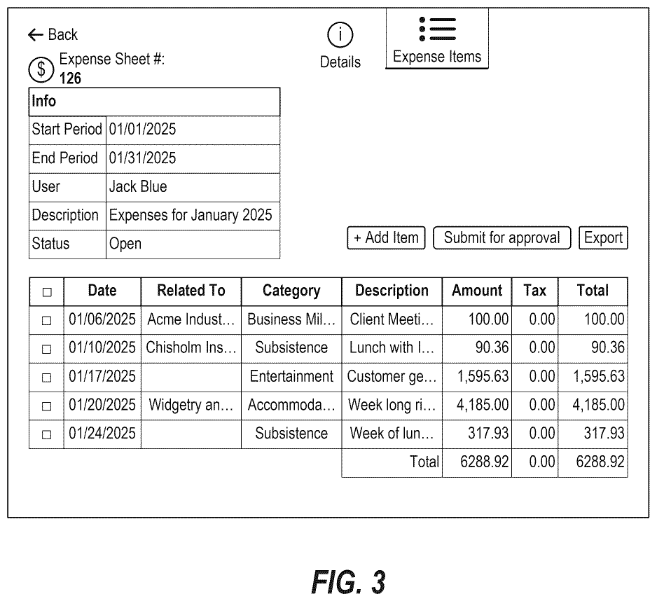

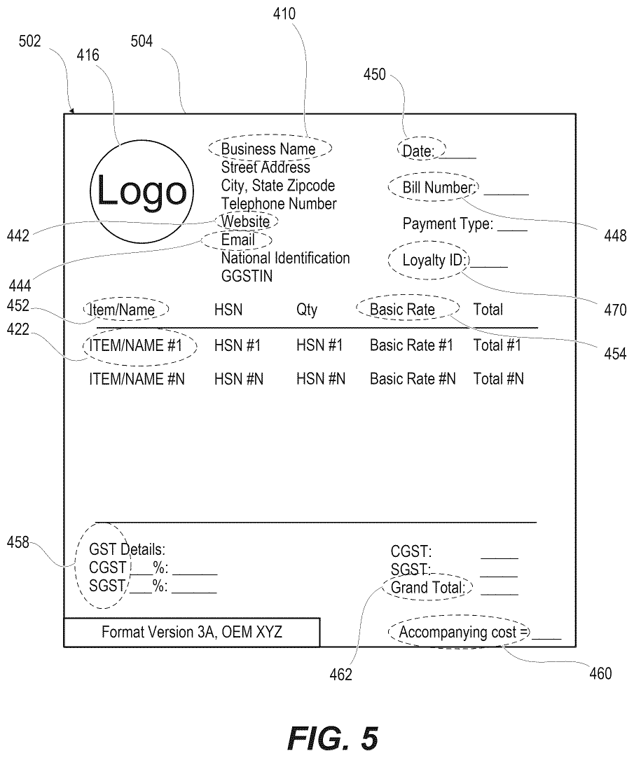

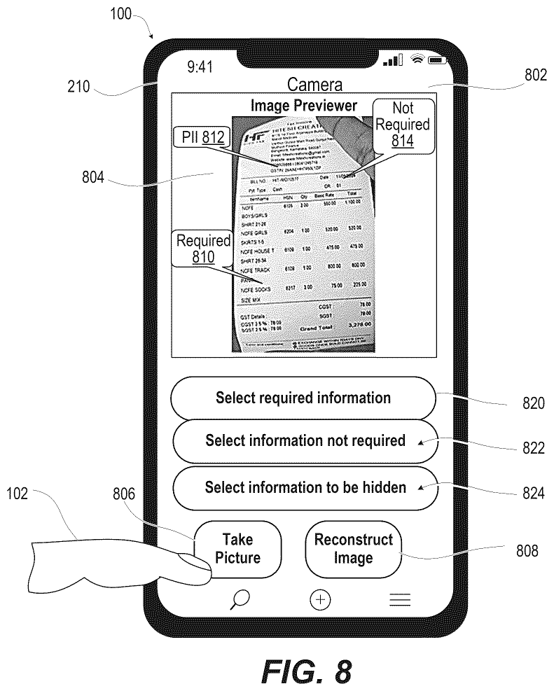

FIG. 2 is a simplified block diagram of operative components and example implementation of electronic device 100 with visual media selective reconstruction (VMSR) module 125. VMSR module 125 is depicted with components for reconstructing required visual information that is at least partially omitted from or partially obstructed within first visual media file 202a of one or more visual media files (VMFs) 202 (e.g., images and videos) that are remotely accessible or retrievable in memory 120. In the example implementation, electronic device 100 has access to, or includes in memory 120, input visual media templates 204 that are associated with corresponding input VMFs 202a (e.g., input image) that are to be reconstructed. An example of input visual media template 204 is described below with regard to FIG. 5. In the example implementation, electronic device 100 has access to, or includes in memory 120, output visual media templates 206 that contain required visual information guiding reconstruction of output VMFs 202b (e.g., an output image). An example of output visual media template 206 is described below with regard to FIG. 3. In the example implementation, electronic device 100 may further include proscribed/confidential data 208 that identifies specific data or types of data that should be omitted, redacted or replaced with generic data (i.e., “anonymized data”) in all instances or in certain circumstances. In an example, a personal attorney may be identified as being allowed to receive all user data whereas a person or office associated with an employer or vendor may be limited or wholly excluded in receiving proscribed/confidential data 208. In the example implementation, input devices 151 and output devices 160 may include touch display 210 that enables and supports user inputs to define required, not-required, and proscribed visual information and to trigger reconstruction. An example of touch display 210 is described below with regard to FIG. 8.

In the example implementation, VMSR module 125 includes media specification requirements component 220, context understanding component 225, relevance filtering component 230, extract metadata from image component 235, optical character recognition (OCR) component 240, text data structure 245, location and date/time data structure 250, extract data fetching component 255, related information data structure 270, and auto replace/fill logic component 275. Extract data fetching component 255 includes web/personal knowledge base (PKB)/global knowledge base (GKB) data structure 260 and parallel communication records component 265.

In an example process flow, VMSR module 125 receives input VMF 202a. A trigger for receiving VMF 202a may be activation of image capturing device 152 to capture an image, video, or other media file. The trigger may be determining that an application interface requires input VMF 202. VMSR module 125 may have previously determined a media specification requirement associated with the application. Media specification requirements component 220 may analyze input VMF 202a and accompany information to associate a previously determined specification for required, not required, and proscribed visual information. Alternatively, or in addition, media specification requirements component 220 may analyze input VMF 202a and accompany information to associate a previously determined specification for required, not required, and proscribed visual information, and forward the media specification to relevance filtering component 230. Alternatively, or in addition, media specification requirements component 220 may analyze input VMF 202a and accompany information to context understanding component 225 to determine refine media specification requirements that are forwarded to relevance filtering component 230. Based on the media specification requirements and the first VMF 202a, relevance filtering component 230 determines, based on the context of use of first VMF 202a, that some or more of the required information within first VMF 202a is at least partially omitted from or obstructed within first VMF 202a. In response, relevance filtering component 230 initiates image reconstruction for the required visual information that is at least partially omitted from or obstructed within first VMF 202a. In identifying the required visual information, relevance filtering component 230 may extract metadata from image component 235 to identify information accompanying first VMF 202a. In an example, the metadata may include location, date, time, user of image capturing device, label entered, etc., of first VMF 202a. The metadata may be retained or stored in location and date/time data structure 250. Relevance filtering component 230 may use optical character recognition (OCR) component 240 to identify visual media information that is visually contained within first VMF 202a and then store the identified text in text data structure 245. Based on available information in the media specification requirements, text data structure 245, and location and date/time data structure 250, extract data fetching component 255 accesses the visual media information that is at least partially omitted from or obstructed within first VMF 202a. AI engine 115 may provide features for finding the relevant and required information. In an example, web/PKB/GKB data structure 260 provides location information in the respective locations. In another example, parallel communication records component 265 may associate communication records that are contemporaneous with or identified as being associated with first VMF 202a in order to obtain the required visual information from the communication records. Extract data fetching component 255 retains or stores the related information that has been fetched in related information data structure 270. Auto replace/fill logic component 275 accesses the related information in related information data structure 270 to reconstruct input VMF 202a as output VMF 202b.

In an example, VMSR module 125 may reconstruct a business lunch receipt for expense reimbursement that unfortunately did not include certain required details (e.g., total amount, date, and restaurant name). Trying to create a realistic reconstruction with conventional manual photo editing applications may be too time consuming and ultimately unconvincing. Trying to find the missing information may also be difficult. Executable functions/features of the VMSR module 125 overcomes these challenges.

In another example, in order to provide a retail address, VMSR module 125 may reconstruct a digital photo of an invoice for school uniforms that a user intends to share with a parent at the same school. By limiting the reconstruction to just the required information of the retail address, the electronic device may forgo looking for information that is not required such as other personal items that were purchased concurrently with school uniform. The targeted processing conserves processing and power resources and expedites completion. In one or more embodiments, VMSR module 125 may further remove, redact, or render generic visual media information present in the first VMF 202a that is visible and that is not required nor suitable for sharing in the current context.

FIG. 3 is example output visual media template 206 containing examples of required visual information. In an example, output visual media template 206 is a completed expense report for a previous month. Although specific visual information may change for each month, the types of required information to be included in output VMF 202b may be determined from output visual media template 206. Examples of required information include transaction dates, related client account, category of expense, description of expense, amount, tax, and transaction total. Mathematical calculations may be identified that total up the category amounts.

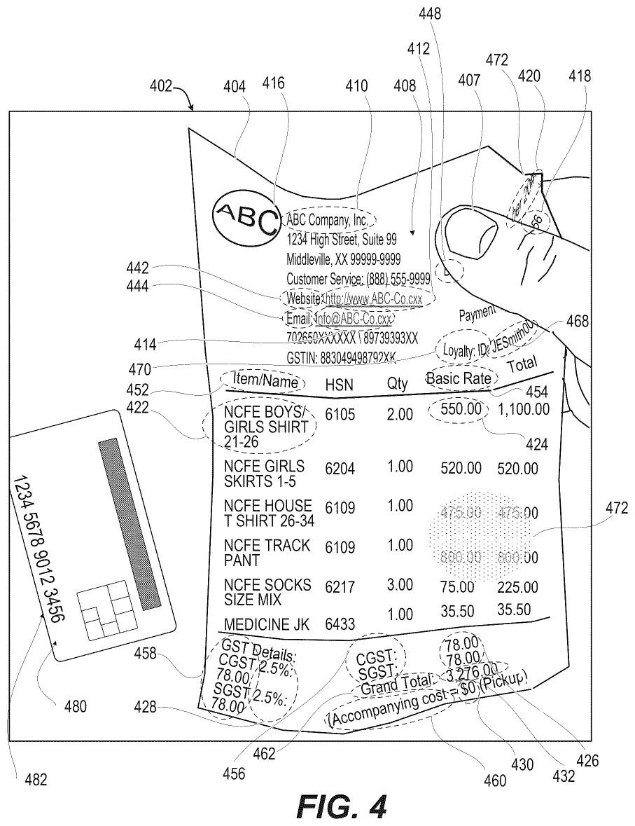

FIG. 4 presents a partially obstructed/obscured image 402 of physical transaction record 404 being held at one corner by hand 406 that provides obstruction 407 to a portion of physical transaction record 404. Physical transaction record 404 is an example of first VMF 202a (FIG. 2). For clarity, processing of physical transaction record 404 is first described with regard to FIGS. 4, 6 and 7 with each example presenting required visual media information that is omitted in or obscured within physical transaction record 404 being reconstructed. In the event that any one of the particular examples of visual media information is not required, no effort is made by the processes described herein to extract and reconstruct that information. In the event that any of the particular examples of visual media is proscribed, the processes described herein include initiating actions to redact, omit, or replace the proscribed visual information. Physical transaction record 404 is nonplanar, presenting descriptive information 408 with different orientations and skew. In the presented example, descriptive information 408 includes the following categories of information: (i) name 410; (ii) website 412; (iii) email address 414; (iii) logo 416; (iv) transaction identifier 418 (partially visible) for a first media transaction; (v) transaction date 420 (partially visible); (vi) at least one transacted item 422; (vii) corresponding transactional price 424 associated with each of at least one transacted item 422; (viii) taxes 426 for the first transaction; (ix) tax rate 428 for at least one transacted item 422; (x) shipping/delivery/processing cost 430 for the first transaction; and (xi) mathematical combination 432 of the transactional price and accompanying costs for at least one transacted item 422. Each category of descriptive information may be accompanied with a category label such as website label 442, email address 444, transaction identifier label 448 (partially obstructed), (v) transaction date label 450 (obstructed, see FIG. 5), transacted item label 452, corresponding transactional price label 454, taxes label 456, tax rate label 458, shipping/delivery/processing cost label 460 (i.e., accompanying costs), and mathematical combination label 462. In one or more embodiments, user loyalty identifier 468 (partially visible) and user loyalty label 470 may indicate that transaction records are accessible at transaction repositories. A user loyalty program accessible via the user loyalty identifiers enables a user to quickly log into a vendor or service provider system. When logged into the user loyalty program, the user may access certain benefits and discounts that are associated with an account of the user. In addition, logging into the user loyalty program may prepopulate financial, shipping and contact information for executing a transaction without having to enter all of the information for each transaction.

Physical transaction record 404 may have at least a portion that is non-perpendicularly positioned with respect to an image capturing device, affecting a skew or scale of descriptive information. Physical transaction record 404 may be bent, curled, or crumbled to create portions that are nonplanar, affecting scale and skew of a portion of the unobstructed descriptive information. The distorted shape may affect reconstruction of obstructed descriptive information. In an example, upper right edge 472 is buckled such that transaction date 420 is skewed and scaled to an extent that renders the descriptive information illegible. Physical transaction record 404 may also include an obstruction that results from surface marring (e.g., erasure or staining). In an example, second obstruction 474 is a stain that darkens a portion of physical transaction record 404 and partially obstructs or obscures descriptive information. In one or more embodiments, physical transaction record 404 may include proscribed/confidential information such as credit/debit card 480 that includes credit/debit card number 482 that is not required for inclusion.

FIG. 5 is a format template 502 associated with hardcopy or physical transaction record 404 (FIG. 4) for a transaction. VMSR module 125 may use format template 502 as example input visual media template 204 (FIG. 2). In an example, identifying the format template 502 may be completed based on what point of sale equipment is being used by a second party or by having an example physical transaction record from the same second party. Format template 502 provides orientation of values and labels. In an example, format template 502 corresponds to example physical transaction record 504, such as a rectangular shape and aspect ratio of format template 502. Example physical transaction record 504 has a two-dimensional shape.

Format template 502 may be created based on analyzing physical hardcopies of transaction records from one or more users from one or more second parties and stored remotely or locally in memory 120 (FIG. 1A). Format template 502 may be received from published information from providers of original equipment manufacturers (OEMs) of printing equipment used by second parties to print transaction records. Format template 502 may be based on finding a previous physical transaction record between user 102 (FIG. 1A) and the same second party. The previous physical transaction record may be captured in an image gallery, may be stored in a communication record (e.g., text or email), or may be stored at a network source (e.g., transaction repositories or security access transaction portals).

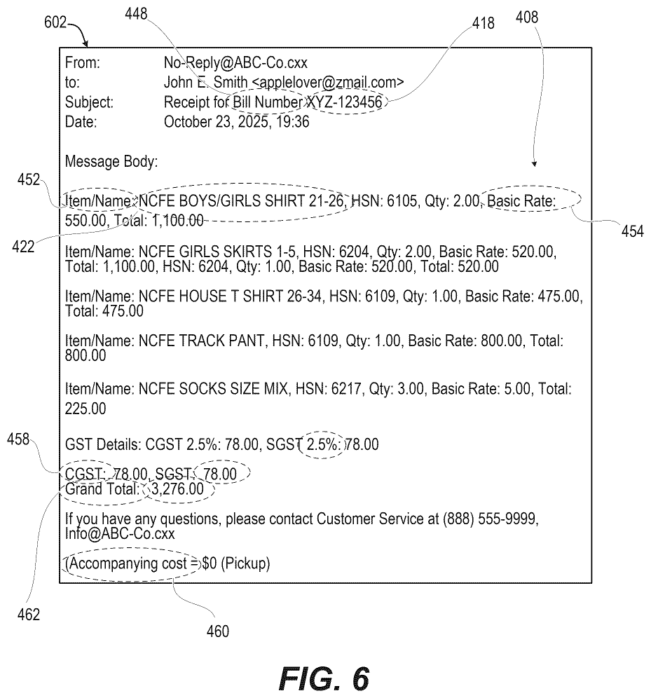

FIG. 6 illustrates transaction record 602 associated with the transaction and containing at least some descriptive information 408. The transaction record 602 may be a communication record, such as an email or text. The transaction record 602 may be web content, such as retrieved from transaction repositories or a second-party web server(s) or a second party web server(s) (e.g., network server 176, application server 190 (FIG. 1B)). In an example, the descriptive information 408 in transaction record 602 may not be formatted the same as physical transaction record 404 and format template 502. In an example, the second party uses one format appropriate for printing a transaction record and uses another format appropriate for emails describing the transaction. Printed receipts tend to be narrow, and emails are often in a document format that renders to a size appropriate for a display device.

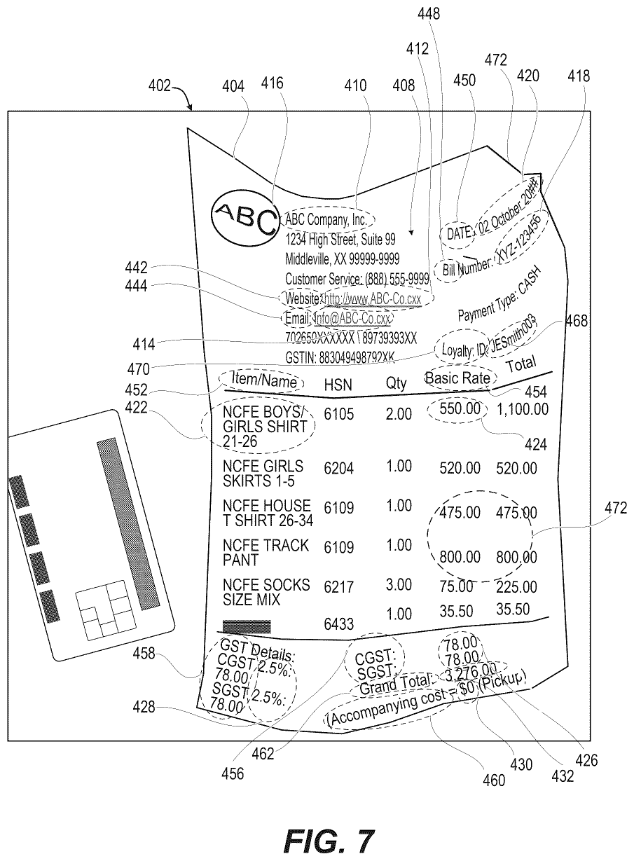

FIG. 7 illustrates reconstructed image 702 that realistically and accurately portrays physical transaction record 404 without obstruction. According to one or more embodiments, reconstructed image 702 is realistically and accurately generated with full descriptive information 408 based on merging and integrating details from partially obstructed/obscured image 402 (FIG. 4), format template 502 (FIG. 5), and transaction record 602 (FIG. 6). Unblocked portions of partially obstructed/obscured image 402 (FIG. 4) are retained in reconstructed image 702. Descriptive information that is obstructed in partially obstructed/obscured image 402 (FIG. 4) is identified using a combination of unblocked portions of partially obstructed/obscured image 402 (FIG. 4), format template 502 (FIG. 5), and transaction record 602 (FIG. 6). The descriptive information taken from transaction record 602 (FIG. 6) are realistically incorporated into reconstructed image 702, using size and location and other formatting aspects of unblocked portions of partially obstructed/obscured image 402 (FIG. 4) and format template 502 (FIG. 5). Descriptive information 408 (FIG. 4) is positioned, oriented, and scaled to match effects of physical transaction record 404 being nonplanar.

In one or more embodiments, reconstruction may include reducing or morphing three-dimensionality of physical transaction record 404 (FIG. 4) to improve legibility of descriptive information. In an example, upper right edge 472 (shown as a dashed line) of partially obstructed/obscured image 402 (FIG. 4) is altered outwardly to flattened upper right edge 472′ of physical transaction record 404. To correspond to the flattened surface, transaction date 420′ and transaction date label 450′ have less skew and increased scale to render the descriptive information legible.

In one or more embodiments, proscribed/confidential information such as credit/debit card 480 (FIG. 4) is redacted, omitted, or replaced with generic information. In an example, credit/debit card 480 is wholly cropped or otherwise redacted from reconstructed image 702. In another example, credit/debit card number 482 (FIG. 4) may be replaced with the same number of digits that do not correspond to an actual account number or that are not legible.

FIG. 8 illustrates touch display 210 of electronic device 100 presenting camera interface window 802 that includes camera preview 804 and camera control affordances, such as take picture control 806 and reconstruct image control 808. In one or more embodiments, electronic device 100 may propose information status for confirmation by user 102, such as required information 810, proscribed information (e.g., PII 812), and not required information 814. In one or more embodiments, reconstruction controls may be provided, such as select required information control 820, select information not required control 822, and select information to be hidden control 824. In one or more embodiments, interactions with user 102 may be aural or touch-based (e.g., Braille output device).

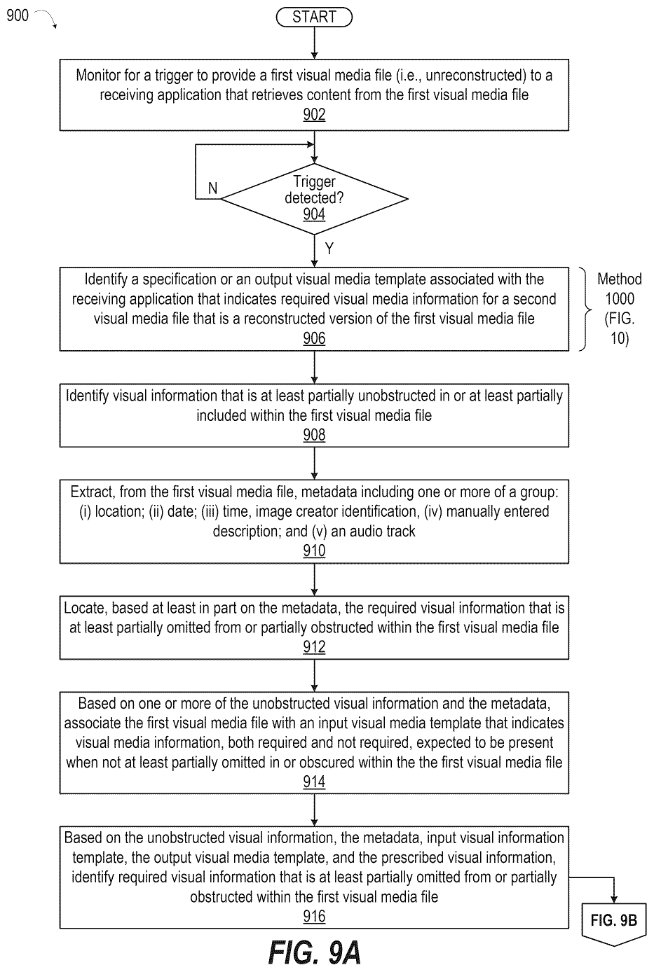

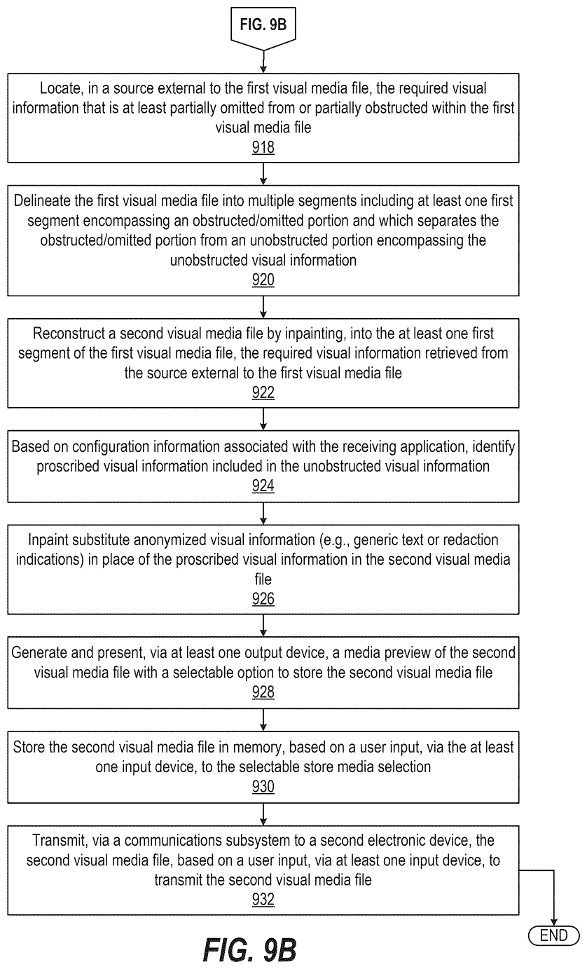

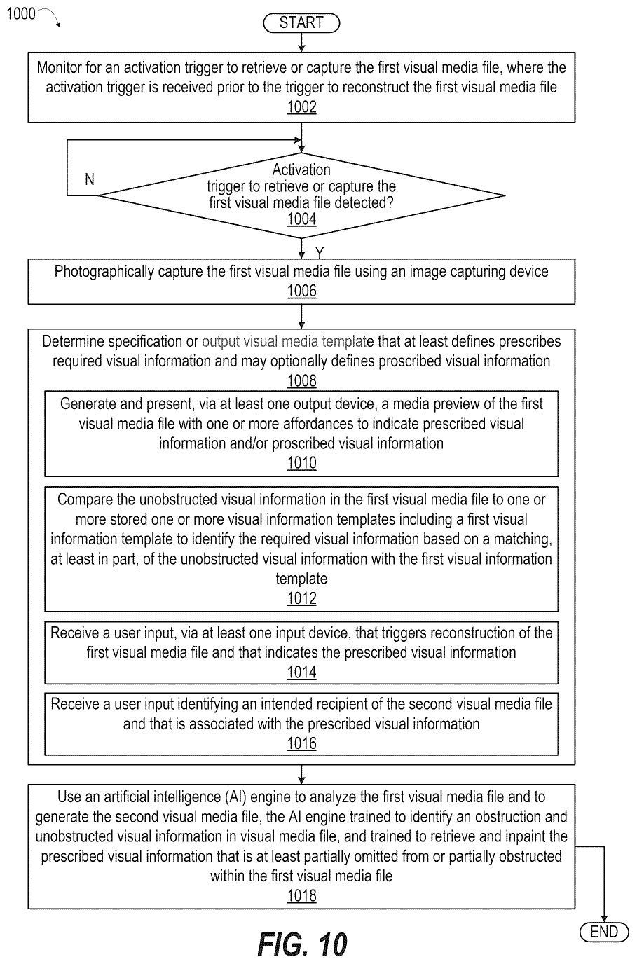

FIG. 9A-9B (collectively “FIG. 9”) is a flow diagram presenting computer-implemented method 900 for reconstructing required visual information that is at least partially omitted from or partially obstructed in a visual media file. FIG. 10 is a flow diagram presenting computer-implemented method 1000 augmenting method 900 (FIG. 9) with techniques for capturing the visual media file and for determining what visual information is required or not required. The descriptions of method 900 (FIG. 9) and method 1000 (FIG. 10) are provided with general reference to the specific components illustrated within the preceding FIG. 1A-1B and 2-8. Specific components referenced in method 900 (FIG. 9) and method 1000 (FIG. 10) may be identical or similar to components of the same name used in describing preceding FIG. 1A-1B and 2-8. In one or more embodiments, controller 110 (FIG. 1A) configures electronic device 100 (FIG. 1A-1B) or a similar computing device to provide the described functionality of method 900 (FIG. 9) and method 1000 (FIG. 10).

With reference to FIG. 9A, method 900 includes monitoring for a trigger to provide a first visual media file (i.e., unreconstructed) to a receiving application that retrieves content from the first visual media file (block 902). Method 900 includes determining whether a trigger is detected to provide a first visual media file to a receiving application that retrieves content from the first visual media file (decision block 904). In an example, the receiving application may be an expense reporter building application. In another example, the receiving application may be a photo editing application. In an additional example, the receiving application is a camera control, which is described below with regard to FIG. 10. In response to determining that a trigger is not detected, method 900 returns to decision block 904. In response to determining that a trigger is detected, method 900 includes Method 900 includes identifying a specification or an output visual media template associated with the receiving application that indicates required visual media information for a second visual media file that is a reconstructed version of the first visual media file (block 906). Examples of determining the specification or the output visual media template are described below with regard to FIG. 10. Method 900 includes identifying visual information that is at least partially unobstructed in or at least partially included within the first visual media file (block 908). Method 900 includes extracting, from the first visual media file, metadata including one or more of a group: (i) location; (ii) date; (iii) time, image creator identification, (iv) manually entered description; and (v) an audio track (block 910). Method 900 includes locating, based at least in part on the metadata, the required visual information that is at least partially omitted from or partially obstructed within the first visual media file (block 912). Method 900 includes, based on one or more of the unobstructed visual information and the metadata, associate the first visual media file with an input visual media template that indicates visual media information, both required and not required, expected to be present when not at least partially omitted in or obscured within the first visual media file (block 914). Method 900 includes, based on one or more of the unobstructed visual information, the metadata, the input visual media template, the output visual media template, and the prescribed visual information, identifying required visual information that is at least partially omitted from or partially obstructed within the first visual media file (block 916). Then method 900 proceeds to block 918 of FIG. 9B.

With reference to FIG. 9B, method 900 includes locating, in a source external to the first visual media file, the required visual information that is at least partially omitted from or partially obstructed within the first visual media file (block 918). Method 900 includes delineating the first visual media file into multiple segments including at least one first segment encompassing an obstructed/omitted portion and which separates the obstructed/omitted portion from an unobstructed portion encompassing the unobstructed visual information (block 920). Method 900 includes reconstructing a second visual media file by inpainting, into the at least one first segment of the first visual media file, the required visual information retrieved from the source external to the first visual media file (block 922). Method 900 includes identifying, based on configuration information associated with the receiving application, proscribed visual information included in the unobstructed visual information (block 924). Method 900 includes inpainting substitute anonymized visual information (e.g., generic text or redaction indications) in place of the proscribed visual information in the second visual media file (block 926). Method 900 includes generating and presenting, via at least one output device, a media preview of the second visual media file with a selectable option to store the second visual media file (block 928). Method 900 may include, based on a user input to the selectable store media selection, via the at least one input device, storing the second visual media file in memory (block 930). Method 900 may include transmitting, via a communications subsystem to a second electronic device, the second visual media file, based on a user input, via at least one input device, to transmit the second visual media file (block 932). Then method 900 ends.

With reference to FIG. 10, method 10 includes monitoring for an activation trigger to retrieve or capture the first visual media file, where the activation trigger is received prior to the trigger to reconstruct the first visual media file (block 1002). Method 1000 includes determining whether an activation trigger is detected to retrieve or capture the first visual media file (decision block 1004). In response to not detecting the activation trigger, method 1000 returns to block 1002. In response to detecting the activation trigger, method 1000 includes photographically capturing the first visual media file using an image capturing device (block 1006). Method 1000 includes determining a specification or an output visual media format that at least prescribes required information and may optionally define proscribed visual information (block 1008). Examples of determining the specification or an output media template include performing one or more processes or techniques of block 1010, 1012, 1014, and 1016. Method 1000 may include generating and presenting, via at least one output device, a media preview of the first visual media file with one or more affordances to indicate prescribed visual information and/or proscribed visual information (block 1010). An example is described above with regard to FIG. 8. Method 1000 may include comparing the unobstructed visual information in the first visual media file to one or more stored visual information templates including a first visual information template to identify the required visual information based on a matching, at least in part, of the unobstructed visual information with the first visual information template (block 1012). Method 1000 may include receiving a user input, via at least one input device, that triggers reconstruction of the first visual media file and that indicates the prescribed visual information (block 1014). Method 1000 may include receiving a user input identifying an intended recipient of the second visual media file and that is associated with the prescribed visual information (block 1016). Method 1000 may include using an artificial intelligence (AI) engine to analyze the first visual media file and to generate the second visual media file. The AI engine trained to identify an obstruction and unobstructed visual information in visual media file, and trained to retrieve and inpaint the prescribed visual information that is at least partially omitted from or partially obstructed within the first visual media file (block 1018). Then method 1000 ends.

According to aspects of the present disclosure, electronic device 100 (FIG. 1A), method 900 (FIG. 9) and method 1000 (FIG. 10), and computer program product, such as RSD 145 (FIG. 1A), provide techniques for reconstructing required visual information that is at least partially omitted from or partially obstructed within the visual media file. As one benefit of the present disclosure, computing resources are not expended on locating and reconstructing visual information that is not required. In one or more embodiments, proscribed visual information (e.g., confidential or personally identifiable information that is not relevant) is redacted, obscured, omitted, or replaced with generic visual information to protect user interests. Also, as another benefit, the user is not inconvenienced or presented with an insurmountable task of repairing a visual media file that lacks required visual media information. Additionally, the user may not have manual photographic editing software to perform the task or may not be sufficiently skilled at this task. The user may be similarly not equipped or efficient in extracting the information that is required.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., does not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
memory that stores a visual media selective reconstruction (VMSR) module; and
a processor communicatively coupled to the memory, and which is configured to cause the electronic device to:
in response to a trigger to provide a first visual media file to a receiving application that retrieves content from the first visual media file:
identify visual information that is prescribed visual information required by the receiving application from the first visual media file;
identify unobstructed visual information in the first visual media;
based on the unobstructed visual information and the prescribed visual information, identify required visual information that is at least partially omitted from or partially obstructed within the first visual media file; and
reconstruct a second visual media file by inpainting, into the first visual media file, the required visual information retrieved from a source external to the first visual media file.

2. The electronic device of claim 1, wherein the processor is further configured to cause the electronic device to:
locate, in the source external to the first visual media file, the required visual information that is at least partially omitted from or partially obstructed within the first visual media file;
delineate the first visual media file into multiple segments comprising at least one first segment encompassing an obstructed/omitted portion and which separates the obstructed/omitted portion from an unobstructed portion encompassing unobstructed visual information; and
reconstruct the second visual media file by inpainting, into the at least one first segment of the first visual media file, the required visual information retrieved from the source external to the first visual media file.

3. The electronic device of claim 1, wherein the processor is further configured to cause the electronic device to:
based on configuration information associated with the receiving application, identify proscribed visual information included in the unobstructed visual information; and
inpaint substitute anonymized visual information in place of the proscribed visual information in the second visual media file.

4. The electronic device of claim 1, wherein the processor is further configured to cause the electronic device to:
extract, from the first visual media file, metadata comprising one or more of a group: (i) location; (ii) date; (iii) time, image creator identification, (iv) manually entered description; and (v) an audio track; and
locate, based at least in part on the metadata, the required visual information that is at least partially omitted from or partially obstructed within the first visual media file.

5. The electronic device of claim 1, wherein the processor is further configured to cause the electronic device to:
identify communication records stored at the source external to the first visual media file; and
locate, in the communication records, the required visual information that is at least partially omitted from or partially obstructed within the first visual media file.

6. The electronic device of claim 1, further comprising at least one input device communicatively coupled to the processor, and wherein the processor is further configured to cause the electronic device to:
receive, via the at least one input device, a user input that triggers reconstruction of the first visual media file; and
determine the prescribed visual information based at least in part on the user input.

7. The electronic device of claim 1, wherein the processor is further configured to cause the electronic device to:
compare the unobstructed visual information in the first visual media file to one or more stored one or more visual information templates comprising a first visual information template; and
identify the required visual information based on a matching, at least in part, of the unobstructed visual information with the first visual information template.

8. The electronic device of claim 1, further comprising at least one input device communicatively coupled to the processor, and wherein the processor is further configured to cause the electronic device to:
receive, via the at least one input device, a user input identifying an intended recipient of the second visual media file; and
associate the intended recipient with the prescribed visual information.

9. The electronic device of claim 1, wherein the VMSR module comprises an artificial intelligence (AI) engine trained to identify an obstruction and unobstructed visual information in visual media file, and trained to retrieve and inpaint the prescribed visual information that is at least partially omitted from or partially obstructed within the first visual media file.

10. The electronic device of claim 1, further comprising an image capturing device communicatively coupled to the processor, and wherein the processor is further configured to cause the electronic device to:
in response to an activation trigger received prior to the trigger to reconstruct the first visual media file, photographically capture the first visual media file using the image capturing device.

11. The electronic device of claim 1, further comprising at least one input device and at least one output device respectively communicatively coupled to the processor, and wherein the processor is further configured to cause the electronic device to:
generate and present, via the at least one output device, a media preview of the first visual media file with one or more affordances to indicate prescribed visual information; and
retrieve and inpaint, based on one or more user inputs, via the one or more input devices, the prescribed visual information.

12. The electronic device of claim 1, further comprising at least one input device and at least one output device respectively communicatively coupled to the processor, and wherein the processor is further configured to cause the electronic device to:
generate and present, via the at least one output device, a media preview of the second visual media file with a selectable option to store the second visual media file; and
store the second visual media file in memory, based on a user input, via the at least one input device, to the selectable store media selection.

13. The electronic device of claim 1, further comprising, a communications subsystem communicatively connectable to a communication network, at least one input device, and at least one output device each respectively communicatively coupled to the processor, and wherein the processor is further configured to cause the electronic device to:
generate and present a media preview of the second visual media file with a selectable option to transmit the second visual media file; and
transmit, via the communications subsystem to a second electronic device, the second visual media file, based on a user input, via the at least one input device, to transmit the second visual media file.

14. A method comprising:
in response to a trigger to provide a first visual media file to a receiving application that retrieves content from the first visual media file:
identifying visual information that is prescribed visual information required by the receiving application from the first visual media file;
identifying unobstructed visual information in the first visual media file;
based on the unobstructed visual information and the prescribed visual information, identifying required visual information that is at least partially omitted from or partially obstructed within the first visual media file; and
reconstructing a second visual media file by inpainting, into the first visual media file, the required visual information retrieved from a source external to the first visual media file.

15. The method of claim 14, further comprising:
locating, in the source external to the first visual media file, the required visual information that is at least partially omitted from or partially obstructed within the first visual media file;
delineating the first visual media file into multiple segments comprising at least one first segment encompassing an obstructed/omitted portion and which separates the obstructed/omitted portion from an unobstructed portion encompassing unobstructed visual information. ; and
reconstructing the second visual media file by inpainting, into the at least one first segment of the first visual media file, the required visual information retrieved from the source external to the first visual media file.

16. The method of claim 14, further comprising:
based on configuration information associated with the receiving application, identifying proscribed visual information included in the unobstructed visual information; and
inpainting substitute anonymized visual information in place of the proscribed visual information in the second visual media file.

17. The method of claim 14, further comprising:
extracting, from the first visual media file, metadata comprising one or more of a group: (i) location; (ii) date; (iii) time, image creator identification, (iv) manually entered description; and (v) an audio track; and
locating, based at least in part on the metadata, the required visual information that is at least partially omitted from or partially obstructed within the first visual media file.

18. The method of claim 14, further comprising:
identifying communication records stored at the source external to the first visual media file; and
locating, in the communication records, the required visual information that is at least partially omitted from or partially obstructed within the first visual media file.

19. A computer program product comprising:
a computer readable storage device; and
program code on the computer readable storage device that when executed by a processor associated with an electronic device, the program code is configured to cause the electronic device to provide functionality of:
in response to a trigger to provide a first visual media file to a receiving application executed by a processor of an electronic device and that retrieves content from the first visual media file:
identifying visual information that is prescribed visual information required by the receiving application from the first visual media file;
identifying unobstructed visual information in the first visual media file;
based on the unobstructed visual information and the prescribed visual information, identifying required visual information that is at least partially omitted from or partially obstructed within the first visual media file;
locating, in a source external to the first visual media file, the required visual information that is at least partially omitted from or partially obstructed within the first visual media file;
delineating the first visual media file into multiple segments comprising at least one first segment encompassing an obstructed/omitted portion and which separates the obstructed/omitted portion from an unobstructed portion encompassing the unobstructed visual information; and
reconstructing a second visual media file by inpainting, into the at least one first segment of the first visual media file, the required visual information retrieved from the source external to the first visual media file.

20. The computer program product of claim 19, wherein the program code is further configured to cause the electronic device to provide functionality of:
locating, in the source external to the first visual media file, the required visual information that is at least partially omitted from or partially obstructed within the first visual media file;
delineating the first visual media file into multiple segments comprising at least one first segment encompassing an obstructed/omitted portion and which separates the obstructed/omitted portion from an unobstructed portion encompassing the unobstructed visual information; and
reconstructing the second visual media file by inpainting, into the at least one first segment of the first visual media file, the required visual information retrieved from the source external to the first visual media file.
